(19) United States
(12) Patent Application Publication
(10) Pub. No.: US 2008/0134721 A1
(43) Pub. Date: Jun. 12, 2008

(54) Method of Bending Glass Sheets

(75) Inventor: Kenji Maeda, Jumet (BE)

Correspondence Address: AKERMAN SENTERFITT, P.O. BOX 3188, WEST PALM BEACH, FL, 33402-3188, US

(73) Assignee: AGC Flat Glass Europe, Jumet (BE)

(21) Appl. No.: 11/908,176

(22) PCT Filed: Mar. 9, 2006
(86) PCT No.: PCT/EP06/60585

§ 371 Date: Sep. 10, 2007

(30) Foreign Application Priority Data
Mar. 10, 2005 (BE) 2005/0130

(51) Int. Cl. C03B 29/08

(52) U.S. Cl. 65/29.1; 65/106; 65/107

(57) ABSTRACT

Glass sheets to be bent are conveyed continuously into a tunnel kiln in which the temperature is adjusted progressively to glass-softening temperature. At least one part of the kiln comprises distributed heating means opposite at least one part of the surface of the sheets, such as to provide a temperature distribution that is selected according to the desired curvature. The heating is distributed using heating elements that are positioned opposite the sheets and the power delivered by each element is selected in order to provide the desired temperature distribution, the movement of the sheet being accompanied by the successive synchronized operation of the heating elements that are disposed along the path thereof.

### The present invention relates to a process and a device for bending glass sheets.

The glass sheets are brought to a high temperature in order to bend them from flat sheets. The bending temperature to which softening of the glass corresponds lies around 600-700° C. Various techniques are used to carry out bending of glass sheets, depending on the nature of the glazing to be produced, its dimensions and its shape.

In the following, it is a question of bending a glass sheet, but the techniques described advantageously apply to the simultaneous bending of two glass sheets when these sheets are intended to subsequently be assembled in laminated form using an intermediate plastic sheet.

Various techniques are used to produce bent glazing, especially glazing intended for the automotive industry. The choice between these techniques depends on both technical and economic factors. The complexity of the shapes to be produced and the high-output production capacities are the main factors.

The most widespread techniques for producing glazing having very accentuated curvatures comprise the at least partial forming of the glass sheet on a bending skeleton or frame which gives its profile to the periphery of the final glazing. The forming takes place at least partly by gravity on the frame.

The bending may be entirely carried out on the frame or also be the subject of a pressing operation which itself may affect either limited portions of the surface of the sheet or the whole of the sheet. One method comprises, for example, a first formation of the glass sheet on the frame, followed by application of the sheet borne by the frame to a counter-mould.

Other techniques combine the bending on the frame with a first forming on a conveyor formed from rollers of which the profile imposes, on the transported glass sheets, a curvature which becomes more pronounced during the progression of the sheets in the bending furnace.

The formation of the sheets according to the desired rigorous shape is all the more difficult to achieve when this shape comprises compound curvatures (bending known as spherical bending as opposed to bending mainly along a single direction, known as cylindrical bending) and when one at least of the curvatures is accentuated and/or of small radius.

The production of such glazing poses problems that the prior art techniques only solve with difficulty, for various reasons.

The bending techniques in question above are all strictly dependent on the thermal conditioning of the sheets. Deformation by gravity is obviously directly dependent on the temperature which conditions the softening of the glass, but even when the deformation is partly carried out by pressing, the temperature level at which this is carried out is important in so far as it controls the degree of ease of deformation and consequently the forces to be applied and the stresses that result therefrom in the sheet.

The temperature distribution that makes it possible to bend the sheets under better conditions is a function of the shape of the glazing produced. This distribution and its application over the time of the process may be relatively difficult to produce in conventional furnaces.

Whatever the technique chosen the formation of the glazing must meet the economic demands of productivity. These demands lead in particular, to choosing the operation modes of the furnaces which enable the highest possible production rates. The production of complex curvatures is currently preferably carried out by passing the glass sheets into furnaces comprising sections in which the conditions are established in a fixed manner as a function of each type of glazing in question. The glass sheets pass “step-by-step” from one section of the furnace to the following, and their treatment is well controlled by the stable conditions established in each section.

The residence time in each section is typically of the order of 20 to 80 seconds, which makes it possible to take good advantage of the particularities of the thermal conditions used in the section in question. Various ways of equipping the step-by-step furnaces have been proposed in the prior art to best meet the demands for conditioning of the glass sheets with complex bends.

Conventional bending furnaces mainly comprise heating elements distributed above and below the glass sheet. In addition, the heating elements are positioned on the sidewalls to maintain a high temperature uniformity at any point in the furnace.

To achieve temperatures that are very different or, as is equivalent, significant temperature gradients in zones of limited dimensions of the sheets, it has been proposed in the prior art to place series of heating elements that stretch out opposite the treated sheet, the spatial distribution and the operation of each element being controlled by the required thermal conditions specific to the forming of the zone facing this element. This is in particular the subject of publication EP 928 779 A1. Still within this objective, it has also been proposed to modulate the distance from the heating elements to the treated glass sheets, and in particular to bring them closer at the glass sheets at locations that require a larger supply of heat. This method of bending is the subject of publication WO 2004/099094 A1. All these measures allow an improvement in the control of the temperature, but are limited by the fact that in “step-by-step” furnaces, a significant part of the time of the process is spent transferring from one zone of the furnace to the next. During this transfer, the temperature gradient drops off for lack of being able to be maintained.

Although the bending furnaces which operate step-by-step offer good possibilities for controlling the thermal conditions, as mentioned above, they have the drawback of limiting the production rates. They also have limits as regards both the dimensions of the sheets which may be treated and the flexibility relating to the change in the treated parts. For these reasons, despite the fact that they are not the most suitable for producing parts with complex bends, continuous furnaces remain widely used.

The object of the invention is to achieve, in continuous furnaces, operating conditions that are as well controlled as those obtained in step-by-step furnaces. For this, the invention proposes to ensure that the heat distribution at the surface of the glass sheet follows its progression.

Since the production rates are fixed as high as possible, the progression of the sheets is relatively rapid. Under these conditions, it is not possible to provide a movement of the heating elements producing the heat distribution in the progression direction of the glass sheets. To some extent it is possible to arrange the mobile heating elements opposite the glass sheets, but independently of the difficulty there may be in arranging the mechanisms that provide the movement of the heating elements, the range of movements that it is possible to make do not allow a sufficiently long following of the sheets in order to reach the required temperature gradients.

The invention proposes to solve this problem by arranging, in the path of the glass sheets, a set of heating elements that cover at least one part of the surface of the sheets and which extend over at least one part of the path in the furnace, the operation of the set of these heating elements being controlled in a programmed manner so that the running of these heating elements accompanies the progression of the sheet to be treated.

The overall heating of the sheets is for a significant part carried out by means of this set of heating elements so as to carefully control the bending process from the moment when it arises. Consequently, it is advantageous to arrange this set of heating elements at least in the part of the furnace in which the softening of the glass is achieved, and preferably before this. For ordinary “float” glass, this corresponds to arranging the set of these heating elements at a point in the furnace where the temperature reaches the value of around 400° C., and optionally even from when it reaches a value of around 300° C.

It is preferred according to the invention to ensure that the set of heating elements in question extends to the end of the heating process in order to maintain the temperature gradients formed as best as possible.

The rate of progression of the glass sheets in the highest-performing bending installations reaches and even exceeds 10 cm/s. It is most often of the order of 5 to 7 cm/s. In practice, a not insignificant treatment time is required in order to form the desired temperature gradient. For this reason, it is necessary to ensure that several elements located one after another can successively heat the glass sheet according to the required distribution.

Furthermore, the location of the zones which must withstand this suitably distributed heating, is not generally oriented along a direction parallel to the progression of the sheets, and does not any longer necessarily extend over the entire height of these sheets. It is therefore necessary to ensure that the use of the heating elements providing this distribution, on the one hand only heats the zones in question to the exclusion of the neighbouring zones (to form the required gradient), and on the other hand that the movement of the sheet is followed by the successive and synchronized intervention of heating elements located in the path of the sheet.

One particular difficulty to be solved is linked to the inertia which characterizes the heating devices. It is necessary to ensure a precise distribution for arranging the elements, of which the temperature rise is as rapid as possible, and similarly of which the decrease which follows takes place rapidly. Heating elements having the first characteristic are commercially available. On the other hand, these same elements have, as will be seen in more detail later on, a certain thermal inertia so that the temperature drop is never as rapid as would be desirable in order to be able to have an instantaneously adjustable heat source in order to follow the most suitable conditions. For this reason, the control of the heating elements must be carried out according to a relatively complex process which integrates this particularity.

The operation of the heating element or elements used is controlled by the dimensions of the zones of the sheet which is the subject of this particular distribution. It is also a function of the rate of progression of the sheets and of the dimensions of the heating element or elements used for this localized heating. Finally, it is a function of the thermal characteristics of the heating element or elements, and also of the distance from this (these) to the glass sheet.

All the preceding considerations (thermal inertia, rate of the sheets, dimensions of the treated zone, dimensions of the heating elements, etc.) means that in practice the operation of the heating element or elements does not follow a continuous regime. Each element follows an operating cycle that depends on the passing of the glass along this element. The successive elements, when several heating elements are used, reproduce the same cycle with a translation corresponding to the displacement of the glass sheet.

The operation of each heating element is a function of the required heat transfer. The heating elements may, for example, be maintained between a relatively low base power, and set at a higher power during passage of the zone of the sheet to be “overheated”.

The heating elements contiguous in the progression direction of the glass sheets may operate successively or, at least over one part of their operating cycle, simultaneously. The start of the operation of successive elements may also comprise a longer or shorter time interval during which no element is supplied with power or is supplied with power in order to deliver a more limited power.

By way of indication, elements with dimensions of around twenty or so centimetres, for glass travelling rates of around 5 cm/s, could thus result in changing the operating time from around 1 to 4 s for zones to be treated of a few tens of centimetres.

The sole control of the heating elements ensuring the temperature distribution of the glass sheet, by regulation of their operation both in terms of power and in terms of time as has just been proposed, may prove inconvenient for effectively and rapidly creating the desired gradients, in particular when the gradient is very high. The “distance” factor contributes particularly effectively to the heat transfer from the heating element to the glass sheet. Consequently, alternatively or cumulatively, the invention proposes to modulate the distributed heat supply by using the distance separating the heating elements from the glass sheet.

In the arrangements described in publication WO 2004/099094 A1, the use of the heating elements is proposed in the context of furnaces mainly of the “step-by-step” type. The movements of the heating elements which follow the progress of the process, are controlled by the necessity of clearing the space required for the displacement of the sheets and their support from one section of the furnace to the next. According to the invention, in a continuous furnace, the movements of the heating elements take place continuously without the progression of the glass sheets being interrupted.

In practice, the simultaneity of the movements of the glass sheet and the operation of the heating element opposite which involves the implementation of the invention, requires means that make it possible to rigorously control their synchronization. This is obtained, for example, using sensors that detect the presence of the sheets and control the selection of the heating elements which must be activated.

To better meet the demands relating to the thermal conditioning of the sheets, the elements for distributed heat supply must be able to establish momentary temperature differences with the remainder of the sheet that are sufficient to facilitate accentuated bending and/or bending comprising radii of curvature which may be of a small dimension. The targeted gradient is that which corresponds to the average temperature in the thickness of the glass sheet, it being understood that, in practice, the heating elements are located for convenience on a single side of the sheet, the gradient will be larger on the side of the sheet directly exposed to the heating elements in question.

The working gradient is a function of the method of obtaining the curvatures. It is highest for curvatures which are only produced by bending under the effect of gravity. When the process used comprises pressing means, the gradient may be much less marked.

The smaller the radii of curvature and the more pronounced the curving effect, the higher the gradient has to be. Depending on the curving effect, and for the processes in which only gravity is involved, the gradient may range up to 10° C./cm. Such high values correspond, for example, to the formation of glazing known as “panoramic” glazing in which the glass sheet is overall U-shaped, the central part of the glazing being flanked by two side parts located in planes orthogonal to this central part.

When the curving effects are less marked, and especially when the technique used comprises the use of pressing means, the gradient may be substantially smaller and may be established, for example, at values of around 5° C./cm or less.

These gradients correspond, over the surface of the glass, to temperature differences which do not normally exceed a hundred or so degrees Celsius. Beyond that, for processes based on deformation by gravity, the control of the curvatures would risk being compromised. For less accentuated curvatures, and processes comprising the forming by pressing the temperature differences do not ordinarily exceed 50° C. and usually are less than 30° C.

In practice, the zone over which the gradient extends is a function of the size of the desired curvature and optionally its radius of curvature. The smaller the radius has to be, the higher the gradient and the smaller the distance on which it is concentrated.

The remainder of the description and the examples are made by referring to the process in which forming is carried out continuously on a frame. The means and devices presented may be used in all the techniques requiring a distributed supply of energy during the bending process.

Other features and advantages of the invention will appear on reading the detailed description which follows, for the understanding of which reference will be made to the appended drawings among which:

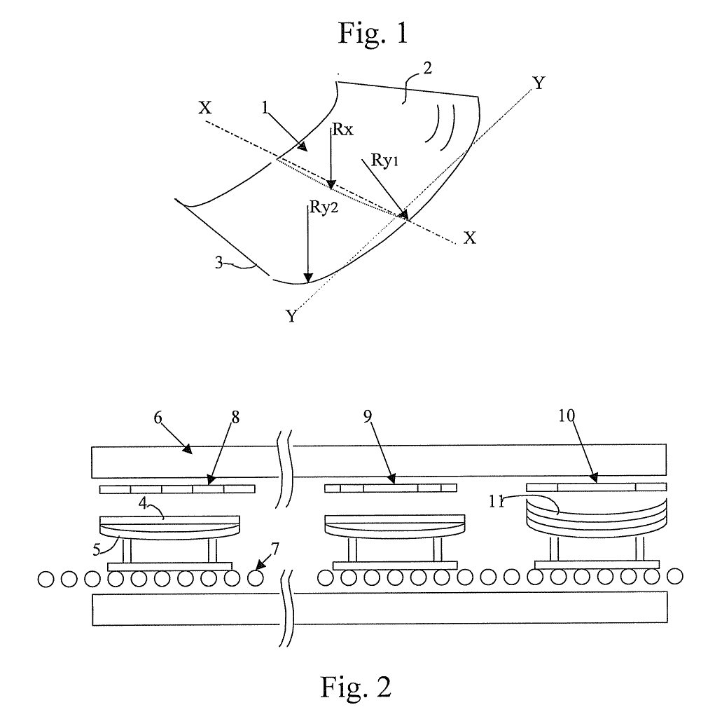

FIG. 1 schematically represents a bent glass sheet having a complex form of the type for which the implementation of the invention proves particularly useful;

FIG. 2 schematically represents a bending process to which the invention may be applied;

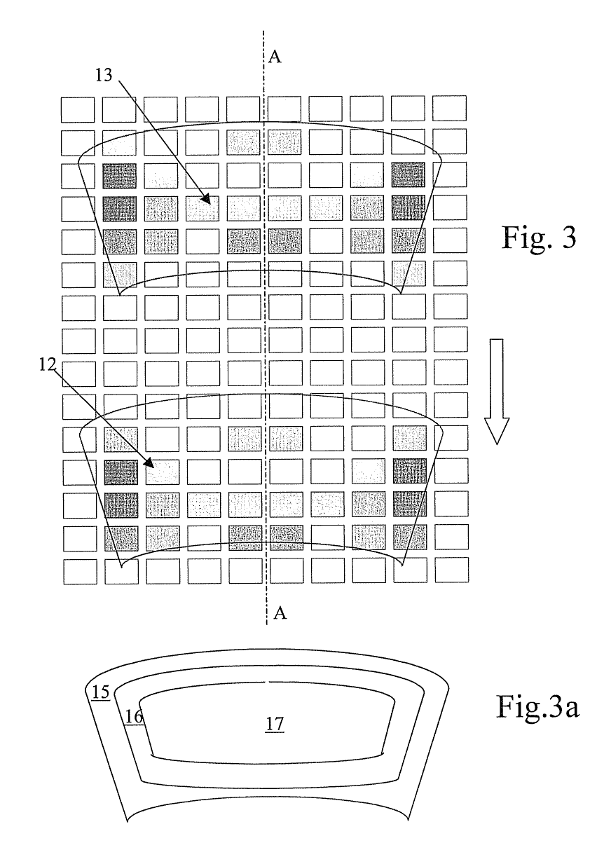

FIG. 3 is a schematic top view of the part of the process from FIG. 2 relative to the invention;

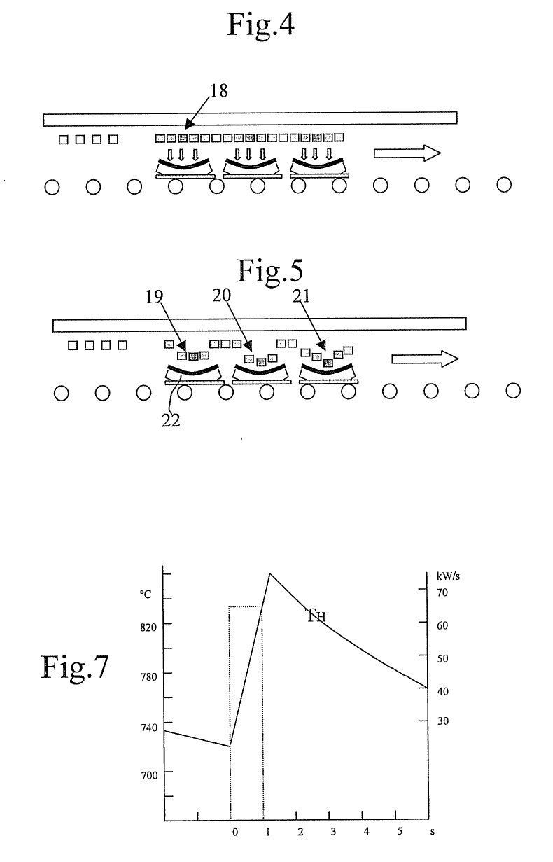

FIG. 4 is a schematic view illustrating one operating mode of the invention;

FIG. 5 is a similar view to that from FIG. 4 of a variant comprising heating elements of which the position is adjustable relative to the glass sheet;

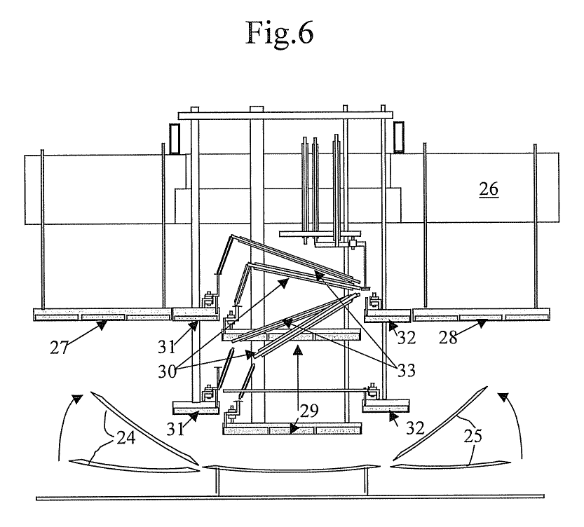

FIG. 6 represents one embodiment of mobile heating elements;

FIG. 7 is a graph illustrating the typical behaviour of an isolated heating element;

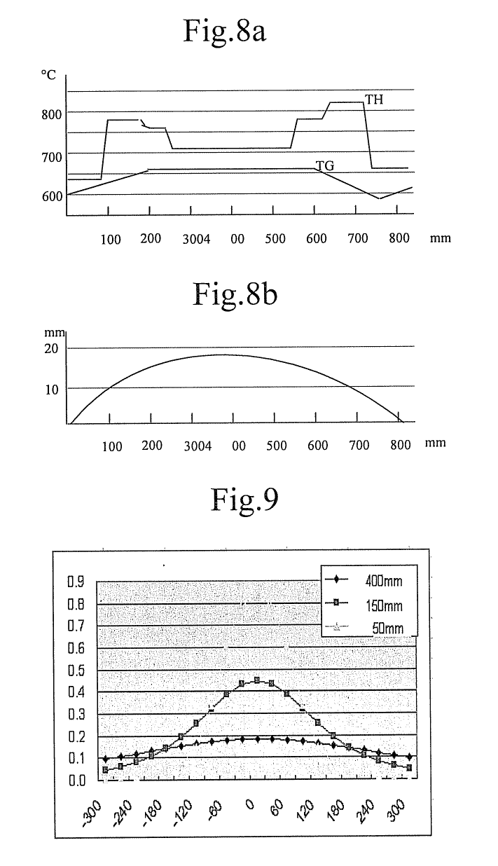

FIG. 8 is a graph illustrating the temperature distribution of a series of heating elements resulting in a particular curvature of the glass sheet; and

FIG. 9 is a graph representing the effect of the distance of the heating element on the intensity of the resulting heating, depending on the part of the sheet considered.

The glass sheet (1) presented in FIG. 1 is of the type comprising a central part of which the radii of curvature (Rx and Ry1) along the directions X and Y, are relatively limited, but which comprises on the edges (2,3) and in the direction Y, wings forming zones of small-radius curvature (Ry2).

The control of the distribution is all the more necessary when the bending is carried out by the simple effect of gravity. In this case, the bending of the glass in these zones must be facilitated without however risking undesired deformations of the zones of the sheet which should only show a limited curvature. For this reason, it is necessary locally, and in a time-limited manner, to establish a significant temperature gradient between this zone of small-radius curvature and the neighbouring zones of much larger radius.

Such a forming method is of the type of that proposed, for example, in the process described in patent publication U.S. Pat. No. 6,240,746 which is represented schematically in FIG. 2.

In this process, the sheet to be bent (4) is placed on a frame (5) which supports it at its periphery. The frame bearing the sheet passes into a tunnel furnace (6) carried by a conveyor (7) driven by a uniform movement. In a first part of the furnace the heating is provided homogeneously by conventional means located in the crown (8), the floor (not shown), and optionally the side walls. The temperature of the sheet is thus brought, for example, to around 400° C. or more, without reaching the softening point of the glass. In the methods described in the abovementioned patent, the temperature of the sheet is then modulated especially by arrangement of the heating elements located in the crown (9,10), these elements being supplied specifically as a function of their position with regard to the glass sheet. The heating is maintained until the complete bending is obtained by gravity.

In variants of this process, the bending by gravity is combined with pressing elements arranged locally at the periphery of the glass sheet, means which ensure the complete and rapid application of the sheet on the frame. In other variants, as indicated previously, the final forming is obtained by applying the frame bearing the sheet to a counter-mould extending over the entire surface of the sheet.

Once the forming is carried out, the sheet (11) borne by the frame (5) is gradually cooled in an annealing step to solidify its shape and give it the desired mechanical properties.

The choice of applying the solutions of the invention, namely creating a distribution of the heating elements so as to create temperature gradients, facilitates the formation of the desired curvatures. The “nominal” curvatures may thus be approached as close as possible.

The difficulty is to arrange to obtain the suitable temperature distribution in a particularly short time when the sheet is moving.

FIG. 3 presents a top view of a diagram of an embodiment of the invention applied, for example, to the process which has just been in question.

The progression of the sheets (12,13) previously heated, approximately uniformly, to a temperature approaching that of the softening point in a tunnel type furnace is continued in this furnace in which the crown is covered with heating elements (H) of limited dimensions, each element being individually controlled with respect to power but also following a cycle over time, according to a pre-established program.

Due to the particular configuration of each type of glazing and the particularities of the furnace, the temperature distribution over the sheet is not generally adapted to the desired bending. The use of a set of elements such as those used according to the invention, makes it possible to re-establish better conditions.

In the envisaged case (FIG. 3), the temperature gradient required is shown schematically by the concentric zones (16,17). In order to obtain a distributed heating resulting in this arrangement, the sheets, in their progression, pass successively under series of heating elements of which the operation is synchronized with the travel of the sheets.

In the diagram from FIG. 3, which shows the arrangement at a given instant, the sheet (12) which precedes the sheet (13) is subjected to the action of heating elements raised to various temperatures. In the figure, the darkest elements correspond to the highest temperatures at a given instant. Previously, the sheet (12) is under the elements such as those which are located at the same time above the sheet (13). In fact, the operating sequence of the heating elements is driven by the same translational movement as that of the sheets (12) and (13).

The dimensions of the heating elements represented are only given by way of illustration. They may vary very significantly. The smaller these elements are, the more precisely the heated zones may be determined. Multiplication of the number of heating elements on the other hand makes the system more complex. Furthermore, the reduction in the dimensions is only of benefit in so far as, as will be seen with regard to FIG. 9, the distance separating these elements from the glass sheet is in proportion with these dimensions.

In the presentation of FIG. 3 only the elements relating to the zones to be “overheated” have their temperature shown. This does not mean that the other elements are not involved in the heating process at the point considered. When these elements participate in the heating, they do so uniformly. In the same way, the characteristics of the elements that are involved in the local “overheating” have the specificity of having a notable temperature difference with respect to the other elements.

It is easily understood that the choice of the elements used specifically during the passage of the zones of the glass sheets to be treated depends on the geometry of these sheets.

In so far as the application of heat must be differentiated as shown in FIG. 3, it is necessary to proceed according to the invention by ensuring the heat supplies follow the movement of the sheets. The operation of these elements cannot be continuous.

Generally, the implementation of the invention comprises the localized heat supply, a heat supply which is controlled in order to be applied in any zone, limited both transversely (Y direction) and longitudinally (X direction), of the glass sheet. Nevertheless, due to the thermal inertia of the heating elements, the “overheated” zones necessarily comprise a component along the X direction.

The implementation principle consists in modulating the operation of the heating elements, a modulation which is controlled as a function of the steady passage of the zone of the sheet of which the temperature must be increased.

The action of each element is controlled over time in order to specifically occur during the passage of the sheet. The sequences of the elements used are moved with the sheet, the elements themselves remaining essentially immobile in the progression direction of the sheets. The absence of mobility of the heating elements avoids the presence of complex mechanisms located in parts of the installation raised to a high temperature. The production of these devices is therefore facilitated.

In order to be able to effectively modulate the heat supply from the heating elements in the manner which has just been indicated, it is necessary to use elements whose characteristics are capable of being modified in an almost instantaneous manner. In practice, it is however necessary to take into account limits of the usual means implemented, especially the thermal inertia of the heating elements and their casing. Elements whose inertia is limited are available commercially. According to the invention, these elements are advantageously used.

The heating elements are moreover advantageously of limited dimensions in order to be able to apply the supply in as precise a manner as possible. In practice however, it is superfluous to seek dimensions which would be less than the distance from the heating elements to the glass sheet due to the inevitable dispersion of the heat supply which entrains this distance. Under these conditions, it is advantageous that the heating elements do not have dimensions of more than 60 cm, and preferably not greater than 40 cm. Dimensions below 10 cm in practice do not bring additional precision for the treated zone, but limit the heat supplies in proportion to their dimension, the power delivered being a function of the resistance and consequently of the surface of these elements opposite the glass sheet.

An example of control of the heating elements is illustrated in FIG. 8a. This example corresponds to that which is presented in FIG. 3. The temperatures are raised along the A-A direction for a glass sheet of which the total height is 830 mm.

FIG. 8a shows the temperature (TH) of the various elements facing the glass sheet at the end of its path in the bending furnace. In this example it can be seen that depending on the part of the sheet concerned, the temperature of the heating elements varies significantly. In this example, the temperature difference may thus be as high as around 150° C., to lead to temperature differences in the sheet (TG) of 60° C. The highest temperatures are those that face the zones with the highest gradients.

In FIG. 8a, the low increase in temperature of the glass raised at the end (830 mm) comes from the presence of a black enamel edge. It is known that the presence of these enamels increases the heat absorption.

By adjusting the temperature of all the heating elements facing the glass sheet, it is understood that it is possible to regulate the temperature of the glass sheet so that the bending has the desired curvatures. Through this precise control, it is possible to give the glazing complex forms with a great precision, for example of less than 0.3 mm with respect to the nominal curvature represented in FIG. 8b.

The graph from FIG. 7 illustrates the operation over time of a heating element as used according to the invention. In the graph, the time in seconds is shown on the x-axis. The temperatures (TH) of the heating element in ° C. are shown on the left hand y-axis, and the indicative energy supplies delivered by the element in question are shown on the right hand y-axis. The operation proposed is here on/off.

The power applied in the case presented is 60 kW. This power is applied instantaneously to study the degree of rapidity of the response which may be obtained using this heating element.

The energy supply passes instantaneously to 60 kW during an interval of one second, then is interrupted. The temperature of the heating element during this brief interval progresses extremely rapidly passing from 720 to 830° C. at the time when the power supply of the element is again interrupted.

The temperature rise of the element is practically linear. Its rapidity takes into account the low inertia of the effectively active part of the heating element. When the power supply is interrupted, the element is cooled but with a decrease which takes into account the inertia of the heating element in its entirety comprising its casing and the manner in which the energy is dissipated from the heating element. The drop in temperature, without any other intervention, extends in the case envisaged over ten or so seconds in order to practically return to the initial temperature. The sheet which continues to be moved under the heating element therefore remains exposed to the radiation coming from this element after the power supply has been interrupted.

In the preceding, the heating elements are distributed uniformly over the crown of the furnace and it is the control of each of the elements which localizes the additional supply of heat and the time during which this supply is maintained. The additional heating is the result of all the heating produced by the various heating elements successively activated during the passage of a glass sheet. The diagram from FIG. 4 illustrates this mode of operation in a very simplified manner.

Another mode of operation takes advantage of the arrangements such as those which are the subject of publication WO 2004/099094. It is presented in FIG. 5 in the same way as FIG. 4 to underline the common elements and those which differentiate these two implementation modes.

In substance, this second implementation mode is distinguished by the fact that the heating elements may be moved closer to the sheet to more precisely establish the desired temperature gradient.

In FIG. 5 the mobile heating elements (19,20,21) are lowered during the passage of the sheets so as to approach them. The movement of these elements must be perfectly synchronized with the progression of the sheets. The movements of each element may be controlled individually or by groups of elements. Furthermore, from one element to the next the movement is not necessarily identical, especially considering the development of the bending. It may be advantageous during the progression of the bending process to increase the displacement of the heating elements to better follow the increase of the curvatures. This is shown schematically in FIG. 5 where the elements, or groups of elements, are gradually lowered further.

The arrangements relating to the mobility of the elements are obviously cumulable with those regarding the power delivered in a cyclic fashion. These two modes for regulating the heat supply may thus reinforce the effect resulting in the formation of the temperature gradient. But it is possible to proceed by maintaining the heating elements at a constant temperature, and only modulating the local supply by the variation of the distance from the heating elements to the glass sheet.

The graph from FIG. 9 shows the distribution of energy over the glass sheet as a function of the distance from a heating element. This element is assumed to have a uniform temperature over its entire surface. In the form presented, the element has relatively large dimensions (width=150 mm). Three distances are indicated 400, 150 and 50 mm.

The graph from FIG. 9 shows the distribution of energy from this element in the transverse direction according to an arbitrary scale. The distances in millimetres are indicated on the x-axis starting from the median plane of the element. It can be seen, over the distribution curves that for the greatest distance the localization effect remains very limited. The energy supply at the centre is not two times that obtained on the edges. Conversely, when the heating element is at a distance of 50 mm from the sheet, the edges are practically unheated and the part concerned by the heating is well concentrated under the heating element.

This concentration of the local heat supply makes it possible to modulate the supply through the play in the distance variation, optionally independently of the power supply of the heating element. This arrangement makes it possible, if necessary, to be freed, at least partially, of the thermal inertia of the heating elements. If need be, the heating elements may deliver a constant power, and only the distance of these elements modulates the local heat supply.

In so far as the positioning of the mobile elements in the furnace is relatively complex, and in that in practice, it is difficult to multiply their number, it is important that the effect of the distance on the localization process is significant as shown in FIG. 9 so long as this distance can be minimized. The establishment of such reduced distances involves, in return, a very precise control of the movement of the heating elements considered.

FIG. 6 reproduces an embodiment of mobile heating elements described in detail in the publication WO 2004/099094, incorporated by reference.

It schematically shows a movement of mobile heating elements used in the bending of a glass sheet on an articulated frame (23).

The figure shows the arrangement of the elements transverse to the progression of the sheets. The symmetry of the whole of the device takes into account that the glazing itself, for example a windscreen, is symmetrical.

In the form presented, the glazing comprises side parts that are greatly raised with respect to the central part. The junction between the side parts and the central part of the glazing comprises zones of high curvature and small radius. These small-radius zones are located at the articulation of the mobile side elements (24,25) of the frame (23). These side elements of the frame are represented on the one hand in an initial “open” position, a position in which the glass sheet is flat, and on the other hand in a raised position corresponding to an intermediate stage of the bending, a stage in which the small-radius curvature is begun. The final bending, not shown, also results in an additional raising of the side parts of the frame to the final “closed” position.

Borne by the crown (26) of the furnace, series of heating elements are arranged symmetrically. Heating elements (27,28) arranged laterally are fixed. They contribute continuously to the establishment of the overall temperature conditions in the furnace. At the centre, a set of heating elements (29) may be displaced vertically from a level corresponding to that of the fixed elements (27,28) to approach to a few centimetres from the glass sheet. The central part (29) and its articulated electrical supply means (30), are presented in two distinct positions. The low position allows an accentuated heating at the centre of the sheet. Such heating is advantageous at the end of the bending process for the sheets which have curvatures not only in the transverse direction represented, but also in the longitudinal direction, that of the progression of the glass in the furnace.

Two other mobile heating elements (31,32) are shown, on the one hand in a raised position, on the other hand in a partially lowered position. These elements are located on both sides of the central element (29). The figure also shows the power supply means (33) associated with these mobile heating elements in the two positions.

Each of the mobile heating elements is independent of the others. In the case considered, the symmetry results in identical and synchronized movements for the heating elements (31) and (32).

The possibility of bringing the heating elements (31) and (32) nearer to the zones of very pronounced curvatures, and similarly the possibility of delivering a specific power to these elements, makes it possible to create the temperature gradient necessary for a bending comprising these curvatures. One particular application of this type of operation is that in which windscreens known as “panoramic” windscreens are produced, windscreens which have on both sides of a central part with moderate curvatures, two side parts joined to the central part by zones of small-radius curvature.

1. Process for bending glass sheets in which the glass sheets to be bent pass in a continuous movement into a tunnel furnace where their temperature is gradually brought to the softening point of the glass, and comprising in one part at least of the furnace a distributed heating of the surface of the sheets, leading to a distribution of the temperatures chosen as a function of the desired curvatures, this distribution of the heating being carried out by means of heating elements located opposite the sheets, the power delivered by each element being chosen so as to lead to the desired temperature distribution, and the movement of the sheet being followed by the successive synchronized operation of the heating elements positioned in the path of progression of the sheets.

2. Process according to claim 1, comprising at least one time during which the glass sheets to be bent are arranged on a frame which supports them at their periphery, the shape of the frame determining the shape of the glazing after the softened glass sheets come to take up the shape of the frame.

3. Process according to claim 1, in which the successive heating elements occurring in the path of the glass sheets establish a temperature gradient, a gradient which does not exceed 10° C./cm.

4. Process according to claim 1, in which the distributed heating is carried out over the glass sheets previously brought to a temperature at least equal to 300° C.

5. Process according to claim 4, in which the distributed heating is carried out over the glass sheets previously brought to a temperature at least equal to 400° C.

6. Process according to claim 1, in which the movement in the furnace is maintained at a rate which does not exceed 10 m/s.

7. Process according to claim 1, in which the heating elements intended for the distributed heating make part of an assembly located opposite the sheet extending over the path of this sheet, the energy transmitted by the elements of this assembly located opposite the zones of the sheet that have to undergo a local overheating of the elements being programmed in such a way that this energy is momentarily increased with respect to that transmitted by the other elements of this assembly.

8. Process according to claim 7, in which the increase in transmitted energy is obtained by a corresponding increase in the power delivered by these elements with respect to the other elements facing the sheet.

9. Process according to claim 7, in which at least some of the elements used to provide the distributed heating of the sheet are mobile and are moved nearer the zone of the sheet in question during passage of it under these elements and are then again moved away from the sheet.

10. Process for improving the flexibility for bending glass sheets of various shapes and dimensions, in which the glass sheets to be bent pass in a continuous movement into a tunnel furnace where their temperature is gradually brought to the softening point of the glass, and comprising in one part at least of the furnace a distributed heating of the surface of the sheets, leading to a distribution of the temperatures chosen as a function of the shapes and dimensions of the various glass sheets, this distribution of the heating being carried out by means of heating elements located opposite the sheets, the power delivered by each element being chosen so as to lead to the desired temperature distribution, and the movement of the sheets being followed by the successive synchronized operation of the heating elements positioned in the path of progression of the sheets.
